(19) United States
(12) Patent Application Publication
(10) Pub. No.: US 2011/0213544 A1
(43) Pub. Date: Sep. 1, 2011

(54) FUEL INJECTION CONTROLLER FOR INTERNAL COMBUSTION ENGINE

(75) Inventors: Tetsuji Mitsuda, Ichinomiya-city (JP); Kuniaki Ueda, Toyota-city (JP)

(73) Assignee: DENSO CORPORATION, Kariya-city (JP)

(21) Appl. No.: 13/033,785

(22) Filed: Feb. 24, 2011

(30) Foreign Application Priority Data
Feb. 26, 2010 (JP) 2010-42090
Mar. 31, 2010 (JP) 2010-80305

(51) Int. Cl. F02D 41/30

(52) U.S. Cl. 701/103

(57) ABSTRACT

When an engine is driven in a high engine-load condition, a split fuel injection is performed in which a required fuel injection quantity is injected by multiple fuel injections. While the split fuel injection is performed, an actual air-fuel ratio of each cylinder is individually computed based on the output of the air-fuel ratio sensor. Based on the actual air-fuel ratio and a reference air-fuel ratio, an injection-quantity variation of each cylinder is computed. A correction value is computed and learned in order to correct the injection-quantity variation of each cylinder.

### CROSS-REFERENCE TO RELATED APPLICATION

This application is based on Japanese Patent Applications No. 2010-42030 filed on Feb. 26, 2010, and No. 2010-80305 filed on Mar. 31, 2010, the disclosures of which are incorporated herein by reference.

### FIELD OF THE INVENTION

The present invention relates to a fuel injection controller for an internal combustion engine. The fuel injection controller is provided with a function that computes variation information about fuel injection quantity injected through a fuel injector when the engine is driven in low engine-load condition. Also, the fuel injection controller is provided with a function that computes an injection-quantity variation of a fuel injector when the engine is driven in low engine-load condition.

### BACKGROUND OF THE INVENTION

JP-2004-183616A (US-2004-0158387A1) shows a fuel injection control system in which air-fuel ratio in each cylinder is estimated by means of a module correlating air-fuel ratio in each cylinder with a detection value of an air-fuel ratio sensor disposed at a confluent portion of exhaust gas. Based on the estimated air-fuel ratio in each cylinder, the fuel injection control system executes an air-fuel ratio control with respect to each cylinder so that variation in air-fuel ratio between cylinders becomes smaller.

A fuel injector used for a direct injection engine has following characteristics. That is, it is likely that linearity in variation characteristics of actual fuel injection quantity (actual fuel injection period) is deteriorated with respect to required fuel injection quantity (required fuel injection pulse) when the required fuel injection quantity is relatively small. Thus, when the engine is driven in low engine-load condition and the required fuel injection quantity is small, a variation in fuel injection quantity becomes larger. The variation in fuel injection quantity represents a deviation between the required fuel injection quantity and the actual fuel injection quantity. As the variation in fuel injection quantity becomes larger, the exhaust emission is increased. The variation in fuel injection quantity is referred to as the injection-quantity variation, hereinafter.

in order to overcome such problems, as shown in the above patent document, the air-fuel ratio control is individually executed with respect to each cylinder. The fuel injection quantity through each fuel injector is corrected so that the injection-quantity variation is reduced. However, when the engine is driven in low engine-load condition, the exhaust gas quantity is decreased and the estimation accuracy of the air-fuel ratio with respect to each cylinder is deteriorated. Thus, the variation in air-fuel ratio between cylinders is hardly obtained with high accuracy. The injection-quantity variation in each cylinder can not be corrected accurately.

JP-2008-128160A (US-2008-0121213A1) shows a fuel injection control system in which air-fuel ratio in each cylinder is estimated by means of a module correlating air-fuel ratio in each cylinder with a detection value of an air-fuel ratio sensor disposed at a confluent portion of exhaust gas. Based on the estimated air-fuel ratio in each cylinder, the system computes a variation in air-fuel ratio between cylinders and executes an air-fuel ratio control with respect to each cylinder so that variation in air-fuel ratio between cylinders becomes smaller. While executing the air-fuel ratio control, the computer learns injection characteristic (injection quantity variation) of each fuel injector based on the variation in the air-fuel ratio of each cylinder which is detected in high engine-load condition and low engine-load condition.

As shown in FIG. 8, a fuel injector used for a direct injection engine has following characteristics. That is, it is likely that linearity in variation characteristics of actual fuel injection quantity is deteriorated with respect to a fuel injection pulse width (fuel injection period) when the fuel injection quantity is relatively small. Thus, when the engine is driven in low engine-load condition and the required fuel injection quantity is small, the injection-quantity variation becomes larger. The injection-quantity variation represents a deviation between the required fuel injection quantity and the actual fuel injection quantity. As the injection-quantity variation becomes larger, the exhaust emission is increased.

However, when the engine is driven in low engine-bad condition, the exhaust gas quantity is decreased and the estimation accuracy of the air-fuel ratio with respect to each cylinder is deteriorated. Thus, the variation in air-fuel ratio between cylinders is hardly obtained with high accuracy. The injection-quantity variation in each cylinder can not be corrected accurately.

### SUMMARY OF THE INVENTION

The present invention is made in view of the above matters, and it is an object of the present invention to provide a fuel injection controller which is capable of obtaining information about injection-quantity variation when the engine is driven in low engine-load condition.

According to the present invention, a fuel injection controller includes an air-fuel ratio sensor provided in an exhaust passage of the internal combustion engine; and an information computing means for performing a split fuel injection in which a required fuel injection quantity is injected by performing multiple fuel injections when the required fuel injection of each cylinder is greater than a specified value.

Based on an actual air-fuel ratio detected by the air-fuel ratio sensor during the multiple fuel injections and a specified reference air-fuel ratio, the information computing means computes an injection-quantity variation or information correlating with the injection-quantity variation in a low engine-load condition where the engine-load is less than a specified value.

When the split fuel injection is performed, the required fuel injection quantity (required fuel injection pulse) per a single injection in the split fuel injection becomes almost the same as the required fuel injection quantity in a low engine-load condition. The injection-quantity variation of each cylinder in performing the split fuel injection becomes almost the same as the injection-quantity variation in a low engine-load condition. During the split fuel injection, the air-fuel ratio deviates by a specified amount which corresponds to the injection-quantity variation when the engine is driven in a low engine-load condition. Further, when the engine is driven in a high engine-load condition and the split fuel injection is performed, the exhaust gas quantity is relatively large, so that the air-fuel ratio detection accuracy of the air-fuel ratio sensor is improved. Therefore, based on the actual air-fuel ratio detected by the air-fuel ratio sensor during the split fuel injection and the reference air-fuel ratio, the variation in air-fuel ratio can be accurately detected. Also, the information about injection-quantity variation in low engine-load condition can be obtained with high accuracy.

According to another aspect of the present invention, a fuel injection controller for an internal combustion engine includes an air-fuel ratio sensor provided in an exhaust passage of the internal combustion engine, and a variation learning means for performing a split fuel injection in which a required fuel injection quantity is injected by multiple fuel injections when the engine is driven in high engine-load condition where the required fuel injection of each cylinder is greater than a specified value. The variation learning means learns an injection-quantity variation in low engine-load condition based on a variation in air-fuel ratio which is obtained from an output of the air-fuel ratio sensor while the split fuel injection is performed. The variation learning means determines a number of times of a fuel injection in the split fuel injection based on a fuel injection quantity which is within a specified fuel injection quantity range where a learning of the injection-quantity variation is executed.

The required fuel injection quantity (required fuel injection pulse width) per a single injection in the split fuel injection becomes almost the same as the required fuel injection quantity (required fuel injection pulse width) in low engine-load condition. The injection-quantity variation of each cylinder in performing the split fuel injection becomes almost the same as the injection-quantity variation in low engine-load condition. During the split fuel injection, the air-fuel ratio deviates by a specified amount which corresponds to the injection-quantity variation when the engine is driven in low engine-load condition. Further, when the engine is driven in high engine-load condition and the split fuel injection is performed, the exhaust gas quantity is relatively large, so that the air-fuel ratio detection accuracy of the air-fuel ratio sensor becomes high.

Therefore, based on the variation in the air-fuel ratio detected by the air-fuel ratio sensor during the split fuel injection, the injection-quantity variation in low engine-load condition can be learned with high accuracy.

Further, since the number of times of fuel injection in the split fuel injection is determined based on the fuel injection quantity in the fuel injection quantity range where the learning is executed, the number of times can be properly determined and the fuel injection quantity per one fuel injection can be surely established within the present fuel injection quantity range. Thus, the injection-quantity variation can be correctly learned.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a schematic view of an engine control system according to a first embodiment of the present invention;

FIGS. 2A and 2B are time charts for explaining a method for computing a fuel injection quantity correction value according to the first embodiment;

FIG. 3 is a flowchart showing a processing of a correction value learning routine according to the first embodiment;

FIG. 4 is a flowchart showing a processing of an injection quantity correcting routine in a low engine-load;

FIGS. 5A and 5B are time charts for explaining a method for computing a fuel injection quantity correction value according to a second embodiment;

FIG. 6 is a flowchart showing a processing of a correction value learning routine according to the second embodiment;

FIG. 7 is a schematic view of an engine control system according to a third embodiment of the present invention;

FIG. 8 is a graph showing an injection characteristic between an injection pulse width and an actual fuel injection quantity,

FIG. 9 is a chart for explaining a method for determining a number of times of a fuel injection in a split fuel injection;

FIG. 10 is a flowchart showing a processing of an injection-quantity variation learning routine according to a third embodiment;

FIG. 11 is a flowchart showing a processing of an injection-quantity variation learning routine according to a fourth embodiment; and

FIG. 12 is a flowchart showing a processing of an injection-quantity variation learning routine according to a fifth embodiment.

### DETAILED DESCRIPTION OF EMBODIMENTS

Embodiments of the present invention will be described, hereinafter.

### First Embodiment

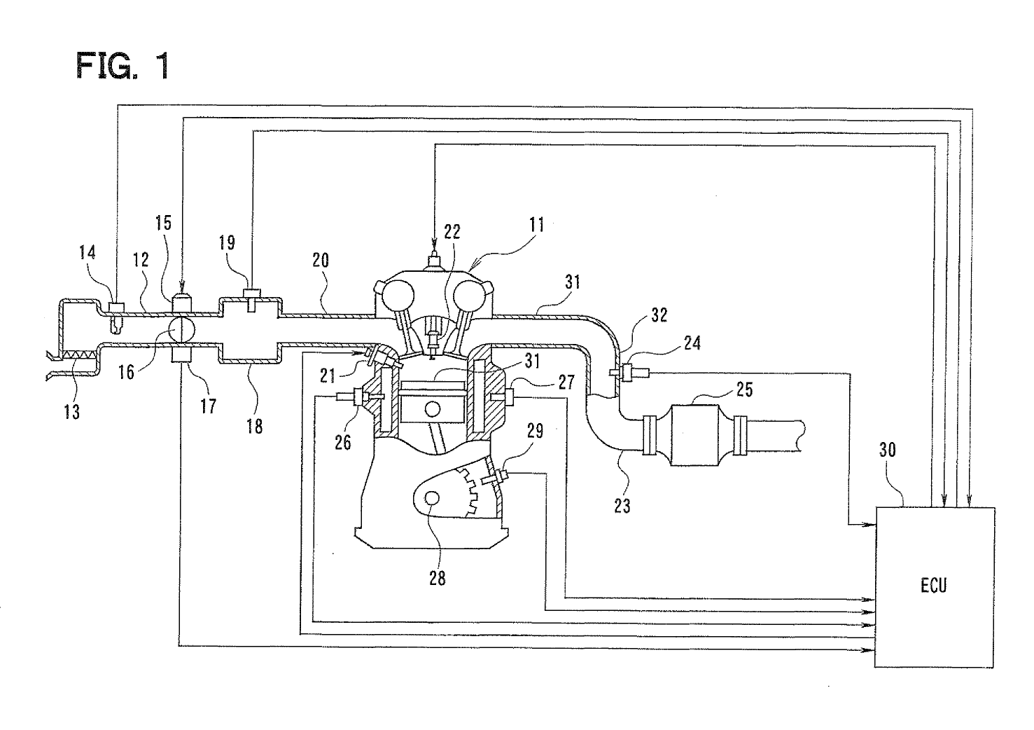

Referring to FIGS. 1 to 4, a first embodiment will be described hereinafter.

FIG. 1 shows an engine control system. An air cleaner 13 is arranged upstream of an intake pipe 12 of an internal combustion engine 11 which is a direct injection engine. An airflow meter 14 detecting an intake air flow rate is provided downstream of the air cleaner 13. A throttle valve 16 driven by a DC-motor 15 and a throttle position sensor 17 detecting a throttle position (throttle opening degree) are provided downstream of the air flow meter 14.

A surge tank 18 including an intake air pressure sensor 19 is provided downstream of the throttle valve 16. The intake air pressure sensor 19 detects intake air pressure. An intake manifold 20 is connected to the surge tank 18. A fuel injector 21 is mounted on each cylinder at a vicinity of an intake air port in order to inject fuel into the cylinder directly. A spark plug 22 is mounted on a cylinder head of the engine 11 corresponding to each cylinder to ignite air-fuel mixture in each cylinder.

At a confluent portion 32 of exhaust manifolds 31 of each cylinder, an air-fuel ratio sensor 24 which detects the air-fuel ratio of the exhaust gas is provided. A three-way catalyst 25 which purifies the exhaust gas is provided downstream of the air-fuel ratio sensor 24.

A coolant temperature sensor 26 detecting a coolant temperature and a knock sensor 27 detecting knocking of the engine are disposed on a cylinder block of the engine 11. A crank angle sensor 29 is installed on a cylinder block to output crank angle pulses when a crank shaft 28 rotates a predetermined angle. Based on this crank angle pulses, a crank angle and an engine speed are detected.

The outputs from the above sensors are inputted into an electronic control unit 30, which is referred to an ECU hereinafter. The ECU 30 includes a microcomputer which executes an engine control program stored in a Read Only Memory (ROM) to control a fuel injection quantity of the fuel injector 21 and an ignition timing of the spark plug 22 according to an engine running condition.

A fuel injector 21 used for a direct injection engine 11 has following characteristics. That is, it is likely that linearity in variation characteristics between the actual fuel injection quantity (actual fuel injection period) and the required fuel injection quantity (required fuel injection pulse) is deteriorated when the required fuel injection quantity is relatively small. Thus, when the engine is driven in low engine-load condition and the required fuel injection quantity is small, the injection-quantity variation of the fuel injector 21 becomes larger. The injection-quantity variation represents a deviation between the required fuel injection quantity and the actual fuel injection quantity. As the injection-quantity variation becomes larger, the exhaust emission is increased.

When the engine 11 is driven in high engine-load condition where engine load is greater than a specified value, the ECU 30 executes a split fuel injection in which the required fuel injection quantity is injected by performing multiple fuel injections. While the split fuel injection is executed, the injection-quantity variation or information about the same is computed based on the actual air-fuel ratio and a reference air-fuel ratio. The actual air-fuel ratio is obtained by the air-fuel ratio sensor 24.

By performing the split fuel injection when the engine is driven in high engine-load condition, the required fuel injection quantity per a single fuel injection can be made almost the same as the required fuel injection quantity in low engine-load condition. The injection-quantity variation in the split fuel injection can be made almost the same as the injection-quantity variation in a case that the engine is driven in low engine-load condition. During the split fuel injection, the air-fuel ratio deviates by a specified amount which corresponds to the injection-quantity variation in a case that the engine is driven in low engine-load condition. Further, when the engine is driven in high engine-load condition and the split fuel injection is executed, the exhaust gas quantity is relatively large, so that the air-fuel ratio detection accuracy of the air-fuel ratio sensor 24 becomes high. Therefore, based on the actual air-fuel ratio detected by the air-fuel ratio sensor 24 during the split fuel injection and the reference air-fuel ratio, the variation in air-fuel ratio due to the injection-quantity variation can be correctly detected. The information about injection-quantity variation in low engine-load condition can be obtained with high accuracy.

It should be noted that an excess air ratio λ representing a ratio between the stoichiometric air-fuel ratio and the current air-fuel ratio will be referred to as the air-fuel ratio λ, hereinafter.

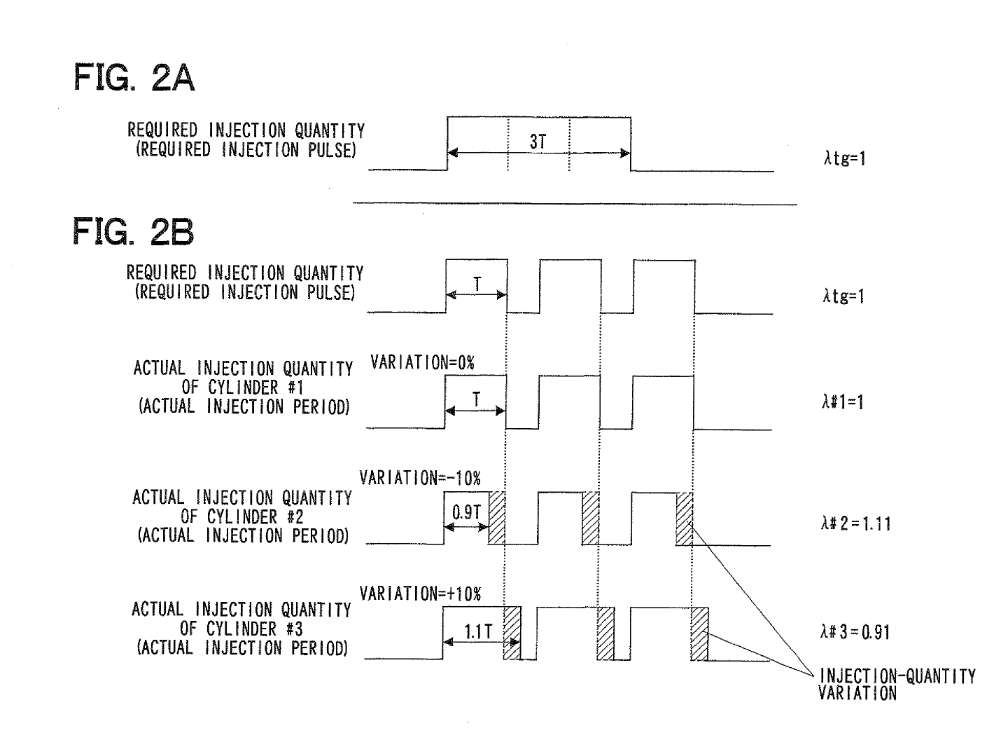

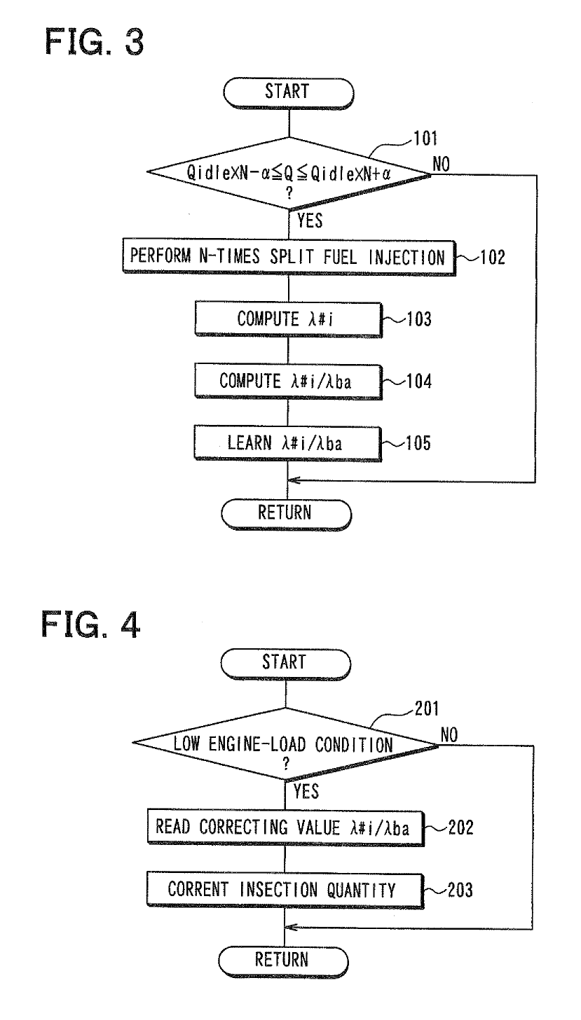

According to the first embodiment, the ECU 30 executes an injection quantity correction value learning routine shown in FIG. 3. This routine is referred to as a learning routine, hereinafter. As shown in FIG. 2A, when the engine is driven in a normal condition where no split fuel injection is necessary, the fuel injector 21 injects the fuel of required fuel quantity by a single injection (normal fuel injection).

As shown in FIG. 2B, when the engine is driven in high engine-load condition, the required air-fuel ratio λtg of each cylinder is maintained at the air-fuel ratio λtg (for example, 1) for the normal fuel injection and each fuel injector 21 injects the fuel of the required fuel injection quantity by performing multiple split fuel injections. The required fuel injection quantity (required fuel injection pulse) per a single injection in the split fuel injection becomes almost the same as the required fuel injection quantity in low engine-load condition, such as idling state. The injection-quantity variation of each cylinder becomes almost the same as the injection-quantity variation in low engine-load condition.

While the split fuel injection is performed, the actual air-fuel ratio λ#i of each cylinder is computed (estimated) by means of a model correlating the detection value of the air-fuel ratio sensor 24 with air-fuel ratio of each cylinder. It should be noted that “#i” represents a cylinder number. In the case of a four-cylinder engine, “i” varies from 1 to 4. For example, in a case that the injection-quantity variation of the fuel injector 21 provided to a first cylinder #1 is “0%”, the actual air-fuel ratio λ#1 of the first cylinder #1 is “1”. In a case that the injection-quantity variation of the fuel injector 21 provided to a second cylinder #2 is “−10%”, the actual air-fuel ratio λ#2 of the second cylinder #2 is “1.11”. In the case that the injection-quantity variation of the fuel injector 21 provided to a third cylinder #3 is “+10%”, the actual air-fuel ratio 2#3 of the third cylinder #3 is “0.91”.

Then, based on the actual air-fuel ratio and a reference air fuel ratio λba (for example, the required air-fuel ratio λtg in high engine-load condition), the information (λ#i/λba) about injection-quantity variation in low engine-load condition is computed with respect to each cylinder. During the split fuel injection, the actual air-fuel ratio λ#i deviates from the reference air-fuel ratio λba by a specified amount which corresponds to the injection-quantity variation in low engine-load condition. Thus, this information (λ#i/λba) is a parameter which accurately indicates the injection-quantity variation of the fuel injector 21 in low engine-load condition.

Such information (λ#i/λba) is learned as a correction value for correcting the injection-quantity variation of each fuel injector 21. The learning value of the correction value (λ#i/λba) is stored in a nonvolatile memory, such as a backup RAM of the ECU 30.

Further, the ECU 30 executes a correction routine shown in FIG. 4 so that the fuel injection quantity of each fuel injector 21 is individually corrected by using of the correction value (λ#i/λba) when the engine 11 is driven in low engine-load condition. In this case, the basic fuel injection quantity of each cylinder may be corrected, or the final required fuel injection quantity (final required fuel injection pulse) of each cylinder may be corrected. For example, in the case that the correction value λ#2/λba is “1.11”, the fuel injection quantity though the fuel injector 21 provided to the second cylinder #2 is corrected to be increased by 11%.

Referring to FIGS. 3 and 4, the processings of the learning routine and the correcting routine will be described hereinafter.

### [Injection Quantity Correction Value Learning Routine]

The learning routine shown in FIG. 3 is executed at a specified time interval while the ECU 30 is energized. This routine functions as a variation information computing means and a correction value learning means.

In step 101, the computer determines whether the required fuel injection quantity Q is within a specified range (Qidle×N−α≦Q≦Qidle×N+α). That is, the computer determines whether it is in high engine-load condition in which a split fuel injection executing condition is satisfied. “Qidle” represents a required fuel injection quantity in low engine-load condition, and “N” is integer greater than or equal to “2”.

When the answer is No in step 101, the routine is finished without performing the subsequent steps. In this case, the normal fuel injection is conducted, in which the required fuel injection quantity “Q” is injected by a single fuel injection.

Meanwhile, when the answer is YES in step 101, the procedure proceeds to step 102. In step 102, N-times split fuel injection is performed in which the required fuel injection quantity Q is injected by performing fuel injections N-times. Thereby, the required fuel injection quantity (required fuel injection pulse) per a single injection in the split fuel injection becomes almost the same as the required fuel injection quantity in a low engine-load condition, such as idling state. The injection-quantity variation of each cylinder becomes almost the same as the injection-quantity variation in a low engine-load condition.

Then, the procedure proceeds to step 103 in which the actual air-fuel ratio λ#i of each cylinder is computed (estimated) based on the output of the air-fuel ratio sensor 24 by using of the model. This process in step 103 corresponds to an air-fuel ratio computing means.

Then, the procedure proceeds to step 104 in which the variation information (λ#i/λba) is computed with respect to each cylinder. Then, the procedure proceeds to step 105 in which the variation information (λ#i/λba is learned as the fuel injection quantity correction value. The learning value of the correction value (λ#i/λba) is stored in a rewritable nonvolatile memory, such as a backup RAM (not shown) of the ECU 30.

### [Injection Quantity Correcting Routine]

An injection quantity correcting routine shown in FIG. 4, which is referred to as the correcting routine, is executed at a specified time interval while the ECU 30 is energized. This routine functions as an injection quantity correcting means. In step 201, the computer determines whether the engine 11 is driven in low engine-load condition, such as idling.

When the answer is NO in step 201, the procedure ends without performing the subsequent steps.

When the answer is YES in step 201, the procedure proceeds to step 202 in which the computer reads the injection quantity correcting value (λ#i/λba) stored in the memory.

Then, the procedure proceeds to step 203 in which the fuel injection quantity of each fuel injector 21 is individually corrected by use of the correcting value (λ#i/λba). In this case, the basic fuel injection quantity of each cylinder may be corrected, or the final required fuel injection quantity (final required fuel injection pulse) of each cylinder may be corrected.

According to the first embodiment described above, when the engine 11 is driven in high engine-load condition in which the required injection quantity is large, the split fuel injection is performed so as to inject the required fuel injection quantity by multiple fuel injections through each fuel injector 21. The required fuel injection quantity (required fuel injection pulse) per a single injection in the split fuel injection becomes almost the same as the required fuel injection quantity in a low engine-load condition. The injection-quantity variation of each cylinder becomes almost the same as the injection-quantity variation in a low engine-load condition. While the split fuel injection is performed, the actual air-fuel ratio λ#i of each cylinder is individually computed based on the output of the air-fuel ratio sensor 24. Based on the actual air-fuel ratio λ#i and the reference air fuel ratio λba, the information (λ#i/λba) about injection-quantity variation in low engine-load condition is computed with respect to each cylinder. Thus, the information (λ#i/λba) about injection-quantity variation can be obtained with high accuracy.

Furthermore, according to the first embodiment, the variation information (λ#i/λba) is learned as the fuel injection quantity correction value with respect to each cylinder. Since the fuel injection quantity of each fuel injector 21 is individually corrected by use of the correction value (λ#i/λba), the injection-quantity variation in each cylinder can be corrected accurately when the engine 11 is driven in low engine-load condition. The injection-quantity variation in each cylinder can be made small enough.

In the above first embodiment, the required air-fuel ratio λtg for performing a normal fuel injection in high engine-load condition is used as the reference air-fuel ratio λba. Alternatively, the actual air-fuel ratio λav (for example, an average of the actual air-fuel ratio) can be used as the reference air-fuel ratio λba. The actual air-fuel ratio λav is detected by the air-fuel ratio sensor 24 when the normal injection is performed. In any cases, the information about injection-quantity variation in low engine-load condition can be computed based on an injection characteristic of the case in which the required fuel injection quantity per a single fuel injection is relatively large.

Alternatively, the actual air-fuel ratio λ#i of a specified representative cylinder can be used as the reference air-fuel ratio λba. The information about the injection-quantity variation in low engine-load condition can be computed based on a fuel injection characteristic of the fuel injector 21 provided to the representative cylinder. cl Second Embodiment

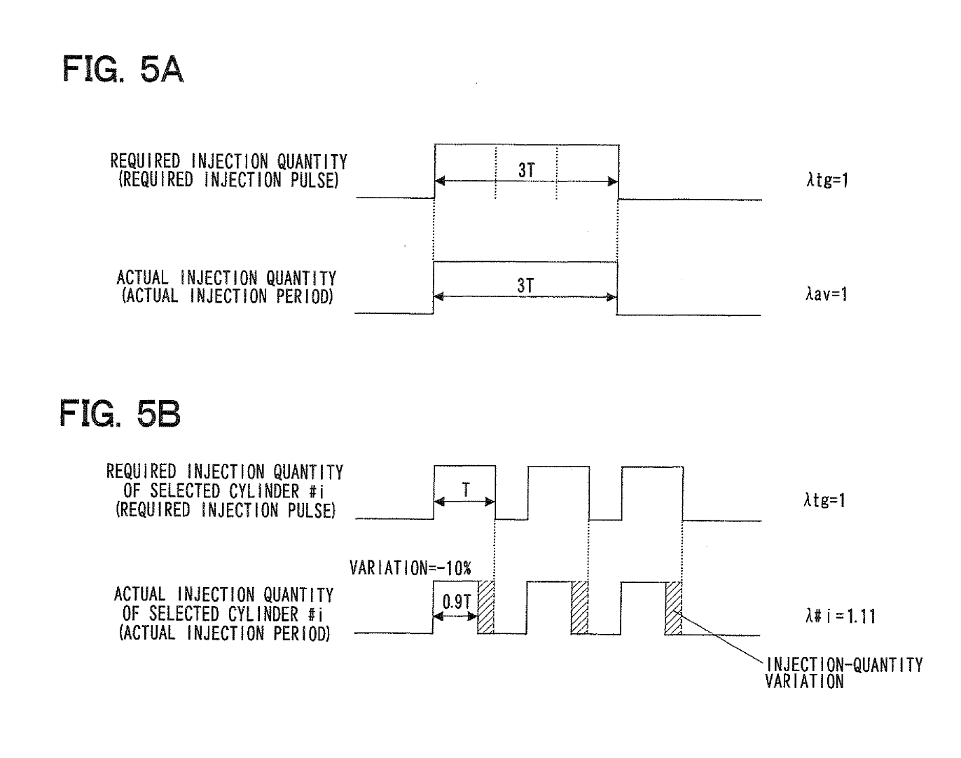

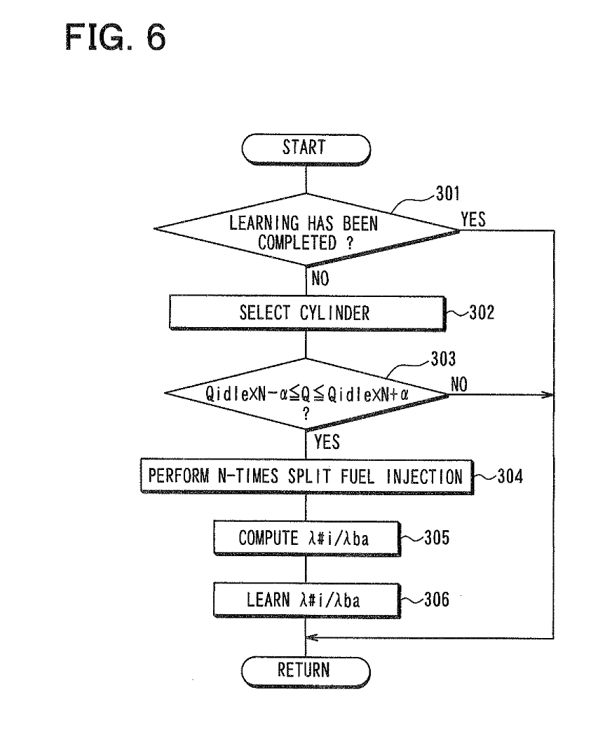

Referring to FIGS. 5 and 6, a second embodiment will be described hereinafter. In the second embodiment, the same parts and components as those in the first embodiment are indicated with the same reference numerals and the same descriptions will not be reiterated.

According to the second embodiment, the ECU 30 executes an injection quantity correction value learning routine shown in FIG. 6. This routine is referred to as a learning routine, hereinafter. As shown in FIG. 5, when the engine is driven in a normal condition where no split fuel injection is necessary, the fuel injector 21 injects the fuel of required fuel quantity by a single injection. When the engine is driven in high engine-load condition, the required air-fuel ratio λtg of each cylinder is maintained at the air-fuel ratio λtg (for example, 1) for the normal fuel injection and only one fuel injector 21 provided to a specified selected cylinder #i injects the fuel of the required fuel injection quantity by multiple split fuel injections. The required fuel injection quantity (required fuel injection pulse) per a single injection in the split fuel injection becomes almost the same as the required fuel injection quantity in low engine-load condition, such as idling state. The injection-quantity variation of the selected cylinder #i becomes almost the same as the injection-quantity variation in low engine-load condition.

Based on the actual air-fuel ratio λ#i detected by the air-fuel ratio sensor 24 during the split fuel injection and the reference air-fuel ration λba (the actual air-fuel ratio λav), the information (λ#i/λba) about injection-quantity variation of the selected cylinder #i is computed. Such variation information (λ#i/λba) is learned as the fuel injection quantity correction value (λ#i/λba) for correcting the injection-quantity variation of the fuel injector 21 provided to the selected cylinder #i. The learning value of the correction value (λ#i/λba) is stored in a rewritable nonvolatile memory, such as a backup RAM (not shown) of the ECU 30.

Until the learning of the correction value (λ#i/λba) is completed with respect to every cylinder, the selected cylinder is changed sequentially, whereby the variation information (λ#i/λba) of each cylinder is computed and the correction value (λ#i/λba) is learned with respect to each cylinder.

The processes of the injection quantity correction value learning routine shown in FIG. 6 will be described hereinafter.

In step 301, it is determined whether the learning of the correction value has been completed with respect to every cylinder in a specified time period. When the answer is NO in step 301, the procedure proceeds to step 302. In step 302, a cylinder where the learning of correction value has not been completed yet is set as the present selected cylinder #i.

Then, the procedure proceeds to step 303 in which the computer determines whether the required fuel injection quantity Q is within a specified range (Qidle×N−α≦Q≦Qidle×N+α). That is, the computer determines whether it is in high engine-load condition in which a split fuel injection executing condition is satisfied.

When the answer is NO in step 303, the routine is finished without performing the subsequent steps. In this case, the normal fuel injection is conducted, in which the required fuel injection quantity “Q” is injected by a single fuel injection.

Meanwhile, when the answer is YES in step 303, the procedure proceeds to step 304. In step 304, the N-times split fuel injection is conducted in which the required fuel injection quantity Q is injected through the fuel injector 21 provided to the selected cylinder #i by performing fuel injections N-times. Thereby, the required fuel injection quantity (required fuel injection pulse) per a single injection in the split fuel injection becomes almost the same as the required fuel injection quantity in low engine-load condition, such as idling state. The injection-quantity variation of selected cylinder #i becomes almost the same as the injection-quantity variation in low engine-load condition.

Then, the procedure proceeds to step 305 in which the variation information (λ#i/λba) of the selected cylinder #i is computed. Then, the procedure proceeds to step 306 in which the variation information (λ#i/λba) is learned as the fuel injection quantity correction value for correcting the injection-quantity variation of the selected cylinder #i. The learning value of the correction value (λ#i/λba) is stored in a rewritable nonvolatile memory, such as a backup RAM (not shown) of the ECU 30.

Until the computer determines that the learning of the correction value (λ#i/λba) is completed with respect to every cylinder, the selected cylinder #i is changed sequentially, whereby the variation information (λ#i/λba) of each cylinder is computed and the correction value (λ#i/λba) is learned with respect to each cylinder.

According to the second embodiment, substantially the same advantage can be achieved as the first embodiment.

The required air-fuel ratio λtg for the normal fuel injection in high engine-load condition can be used as the reference air-fuel ratio λba. In any cases, the information about injection-quantity variation of the selected cylinder in a low engine-load condition can be computed based on an injection characteristic of the case that the required fuel injection quantity per a single fuel injection is relatively large.

In the above embodiments, the information (λ#i/λba) about injection-quantity variation of each cylinder is computed. Based on the actual air-fuel ratio λ#i and the reference air fuel ratio λba, the injection-quantity variation of the fuel injector 21 provided to each cylinder may be computed. Further, based on the injection-quantity variation of each cylinder, the correction value may be computed and learned in order to correct the injection-quantity variation of each cylinder.

### Third Embodiment

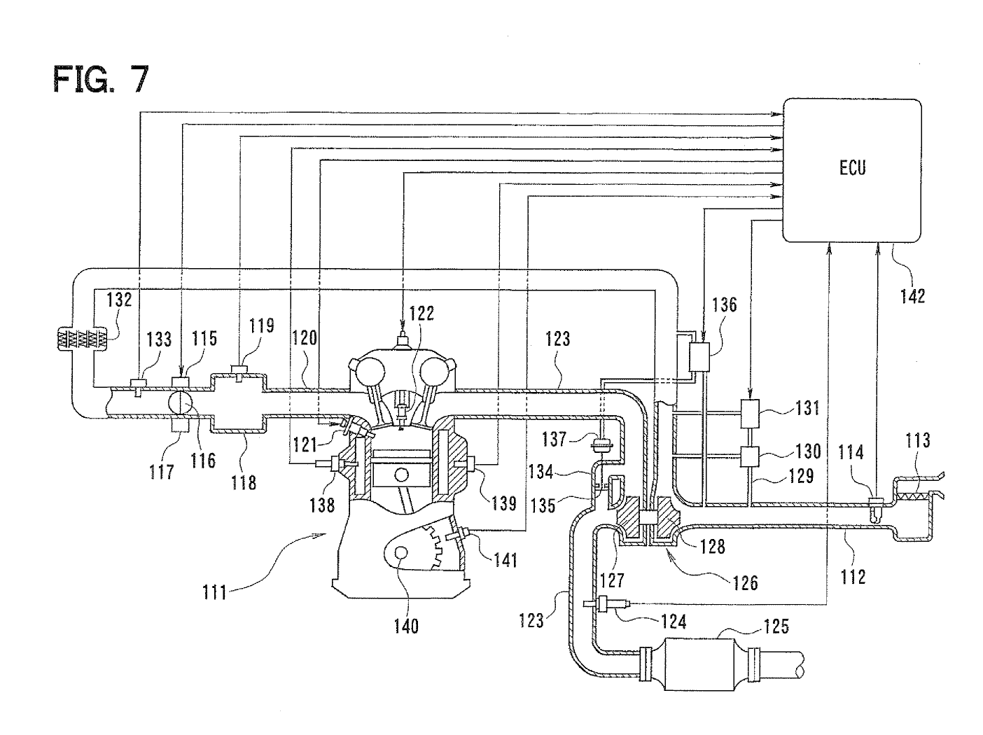

Referring to FIGS. 7 to 10, a third embodiment will be described hereinafter.

FIG. 7 shows an engine control system according to the third embodiment. An air cleaner 113 is arranged upstream of an intake pipe 112 of an internal combustion engine 111 which is a direct injection engine. An airflow meter 114 detecting an intake air flow rate is provided downstream of the air cleaner 113. A compressor 128 of a turbocharger 126 and an intercooler 132 are provided downstream of the airflow meter 114. A boost pressure sensor 133 is provided downstream of the interceder 132 in order to detect boost pressure upstream of a throttle valve 116. The throttle valve 116 driven by a DC-motor 115 and a throttle position sensor 117 detecting a throttle position (throttle opening degree) are provided downstream of the boost pressure sensor 133.

A surge tank 118 including an intake air pressure sensor 119 is provided downstream of the throttle valve 116. The intake air pressure sensor 119 detects intake air pressure downstream of the throttle valve 116. An intake manifold 120 is connected to the surge tank 118. A fuel injector 121 is mounted on each cylinder at a vicinity of an intake air port in order to inject fuel into the cylinder directly. A spark plug 122 is mounted on a cylinder head of the engine 111 corresponding to each cylinder to ignite air-fuel mixture in each cylinder.

An air-fuel ratio sensor 124 detecting an air-fuel ratio of the exhaust gas is provided downstream of a turbine 127 of the turbocharger 126 in an exhaust pipe (an exhaust passage) 123. A three-way catalyst 125 purifying the exhaust gas is provided downstream of the air-fuel ratio sensor 124.

The engine 111 is provided with the turbocharger 126. A turbocharger 126 includes an exhaust gas turbine 127 arranged upstream of the air-fuel ratio sensor 124 in the exhaust pipe 123 and a compressor 128 arranged between the airflow meter 114 and the throttle valve 116. This turbocharger 126 has well known configuration in which the intake air is supercharged into the combustion chamber.

Furthermore, an intake bypass passage 129 bypassing the compressor 128 is connected to the intake pipe 112. An air-bypass-valve (ABV) 130 is disposed in the intake bypass passage 129 to open/close the intake bypass passage 129. An opening degree of the ABV 130 is controlled by a vacuum switching valve (VSV) 131.

An exhaust bypass passage 134 bypassing the exhaust gas turbine 127 is connected to the exhaust pipe 123. A waste gate valve (WGV) 135 is disposed in the exhaust bypass passage 134 to open/close the exhaust bypass passage 134. An opening degree of the WGV 135 is controlled by a diaphragm actuator 137. The diaphragm actuator 137 is controlled by a vacuum switching valve (VSV) 136 for the WGV 135.

A coolant temperature sensor 138 detecting a coolant temperature and a knock sensor 139 detecting knocking of the engine are disposed on a cylinder block of the engine 111. A crank angle sensor 141 is provided on a cylinder block to output crank angle pulses when a crank shaft 140 rotates a predetermined angle. Based on this crank angle pulses, a crank angle and an engine speed are detected.

The outputs of the sensors are inputted to an electronic control unit (ECU) 142. The ECU 142 includes a microcomputer which executes an engine control program stored in a Read Only Memory (ROM) to control a fuel injection quantity of the fuel injector 121 and an ignition timing of a spark plug 122 according to an engine running condition.

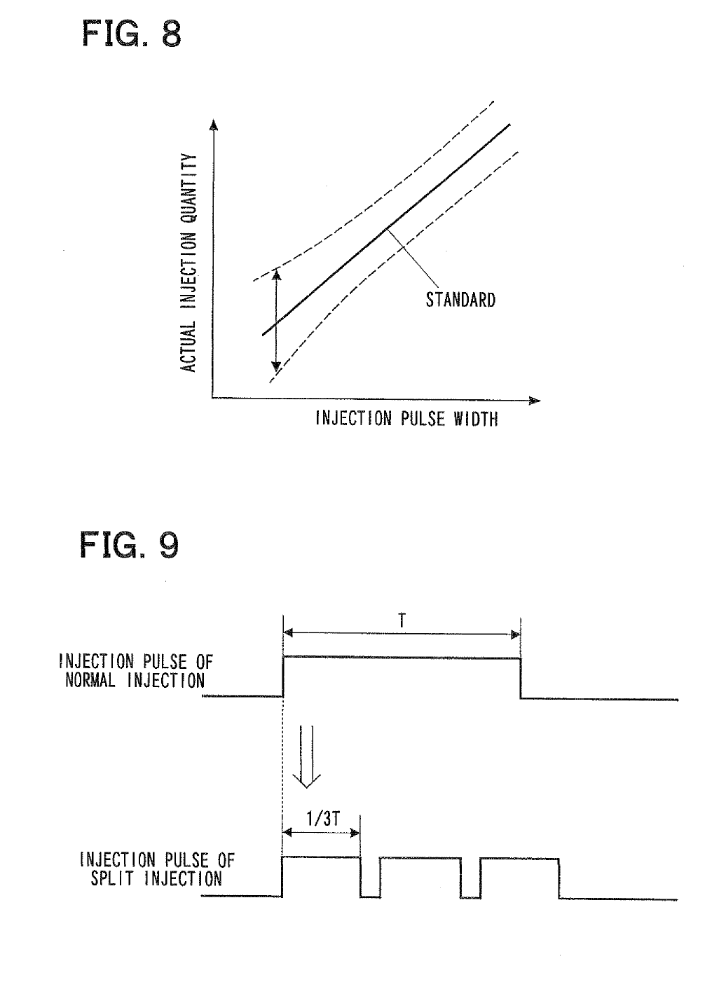

As shown in FIG. 8, the fuel injector 121 used for a direct injection engine 111 has following characteristics. That is, it is likely that linearity in variation characteristics of an actual fuel injection quantity relative to a fuel injection pulse width (fuel injection period) is deteriorated when the fuel injection quantity is relatively small. Thus, when the engine is driven in low engine-load condition and the required fuel injection quantity is small, the injection-quantity variation of the fuel injector 121 becomes larger. The injection-quantity variation represents a deviation between the required fuel injection quantity and the actual fuel injection quantity. As the injection-quantity variation becomes larger, the exhaust emission is increased.

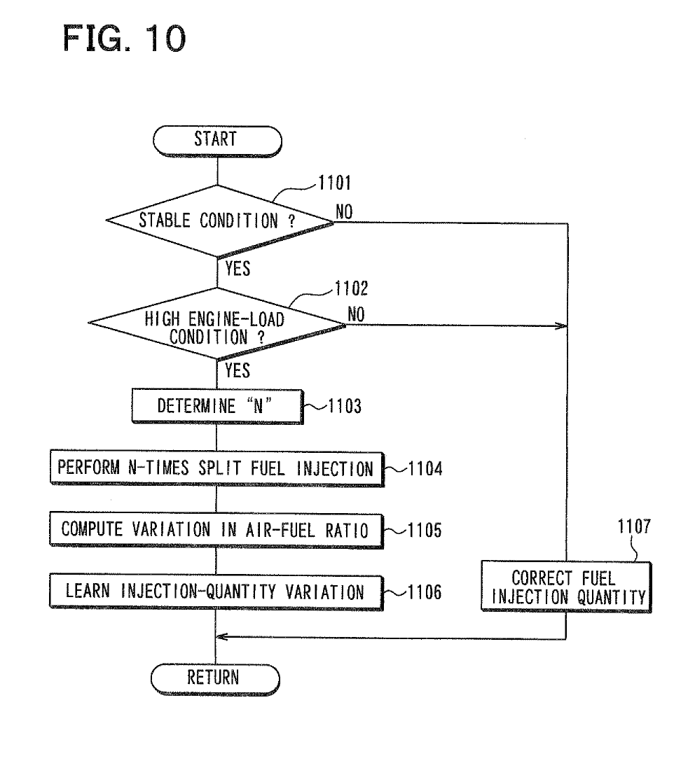

According to the present embodiment, the ECU 142 executes an injection-quantity variation learning routine shown in FIG. 10. When the engine 111 is driven in high engine-load condition in which engine load is greater than a specified value, the ECU 142 executes a split fuel injection in which the required fuel injection quantity Qtotal is injected by multiple fuel injections. Based on the air-fuel ratio variation obtained from the output of the air-fuel ratio sensor 124 during the split fuel injection, the injection-quantity variation of the fuel injector 121 in low engine-load condition is learned.

By performing the split fuel injection in high engine-load condition, the required fuel injection quantity (fuel injection pulse width) per a single injection in the split fuel injection becomes almost the same as the required fuel injection quantity in low engine-load condition. The injection-quantity variation of each cylinder becomes almost the same as the injection-quantity variation in low engine-load condition. During the split fuel injection, the air-fuel ratio deviates by a specified amount which corresponds to the injection-quantity variation in the case where the engine is driven in low engine-load condition. Further, when the engine is driven in high engine-load condition and the split fuel injection is performed, the exhaust gas quantity is relatively large, so that the air-fuel ratio detection accuracy of the air-fuel ratio sensor 124 is improved. The air-fuel ratio variation obtained from the output of the air-fuel ratio sensor 124 during the split fuel injection is good information which reflects injection-quantity variation of the fuel injector 121 in low engine-load condition. Based on this variation in the air-fuel ratio, the injection-quantity variation in low engine-load condition can be learned with high accuracy.

When the injection-quantity variation in low engine-load condition is learned, the number N of split fuel injection is determined based on the fuel injection quantity Qapd. “N” is an integer greater than or equal to “2”. As shown in FIG. 9, in the case that the fuel injection quantity variation is learned with respect to a specified fuel injection quantity including the fuel injection quantity Qapd (for example, minimum fuel injection quantity), the number N of split fuel injection is obtained based on the following formula.

N=Qtotal/Qapd (truncate after the decimal point)

For example, in the case that Qtotal/Qapd=3.2, the number N is defined as “3” (N=3).

Thereby, the number N of split fuel injection is properly defined, and the fuel injection quantity per a single fuel injection (Qtotal/N) is defined as a current fuel injection quantity in which the learning is executed.

Referring to FIG. 10, a processing of the injection-quantity variation learning routine will be described hereinafter.

The injection-quantity variation learning routine is executed at a specified time interval while the ECU 142 is energized. This routine functions as an injection-quantity variation learning means. In step 1101, the computer determines whether the engine driving condition (engine speed, engine load and the like) is stable. When the answer is YES in step 1101, the procedure proceeds to step 1102 in which the computer determines the engine is driven in high engine-load condition where the required fuel injection quantity Qtotal is larger than that in low engine-load condition. Specifically, the computer determines whether the engine is driven in high engine-load condition based on the intake air flow rate, the intake pressure, the throttle position, the exhaust gas flow rate, the required fuel injection quantity and the like.

When the answer is YES in step 1102, the procedure proceeds to step 1103 in which the number N of split fuel injection is determined.

N=Qtotal/Qapd

It should be noted that the fuel injection quantity range in which the learning is executed can be changed at specified time interval.

Then, the procedure proceeds to step 1104 where N-times split fuel injection is performed in which the required fuel injection quantity Qtotal is injected by N-times fuel injections. Thereby, the required fuel injection quantity (required fuel injection pulse width) per a single injection in the split fuel injection becomes almost the same as the required fuel injection quantity in low engine-load condition. The injection-quantity variation of each cylinder becomes almost the same as the injection-quantity variation in low engine-load condition.

Then, the procedure proceeds to step 1105 in which the air-fuel ratio of each cylinder is estimated based on the output of the air-fuel ratio sensor 124 by using of a model which correlates the detection value of the air-fuel ratio sensor 124 with the air-fuel ratio of each cylinder. By computing a deviation between the estimated air-fuel ratio and the reference air-fuel ratio, the variation in air-fuel ratio of each cylinder is individually computed. This process in step 1105 corresponds to an air-fuel ratio variation computing means.

Then, the procedure proceeds to step 1106 in which the injection-quantity variation of each fuel injector 121 in low engine-load condition is individually computed based on the variation in air-fuel ratio of each cylinder. When the air-fuel ratio varies in rich direction by “X%”, the injection-quantity variation is obtained as “+X%”. When the air-fuel ratio varies in lean direction by “Y%”, the injection-quantity variation is obtained as “−Y%”. These computed injection-quantity variation of each cylinder is stored as learning values in a nonvolatile memory, such as a backup RAM of the ECU 142.

When the answer is NO in step 1101, or step 1102, the procedure proceeds to step 1107 in which the computer reads the learning values of the injection-quantity variation of each cylinder, which correspond to the current required fuel injection quantity. Based on these learning values, the computer individually corrects the fuel injection quantity with respect to each fuel injector 121. In this case, the basic fuel injection quantity of each cylinder may be corrected, or the final required fuel injection quantity (final required fuel injection pulse width) of each cylinder may be corrected.

According to the third embodiment described above, when the engine 111 is driven in high engine-load condition in which the required injection quantity is larger than a specified value, the split fuel injection is performed so as to inject the required fuel injection quantity by multiple fuel injections through each fuel injector 121. The required fuel injection quantity (required fuel injection pulse width) per a single injection in the split fuel injection becomes almost the same as the required fuel injection quantity (required fuel injection pulse width) in low engine-load condition. The injection-quantity variation of each cylinder becomes almost the same as the injection-quantity variation in low engine-load condition. The injection-quantity variation in low engine-load condition can be learned with high accuracy. Further, since the number N of split fuel injection is determined based on the fuel injection quantity Qapd in the fuel injection quantity range where the learning is executed, the number N can be properly determined and the fuel injection quantity per a single fuel injection can be surely established within the present fuel injection quantity range. Thus, the injection-quantity variation can be correctly learned.

According to the present embodiment, while performing the split fuel injection, the variation in air-fuel ratio is individually computed with respect to each cylinder and the injection-quantity variation is learned based on the variation in air-fuel ratio of each cylinder. Thus, the injection-quantity variation of each cylinder can be learned at one time.

Furthermore, since the fuel injection quantity of each fuel injector 121 is individually corrected by using of the learning value of the injection-quantity variation of each fuel injector 121 when the engine 111 is driven in low engine-load condition, the injection-quantity variation in each cylinder can be corrected accurately when the engine 111 is driven in low engine-load condition. The injection-quantity variation in each cylinder can be made small enough.

### Fourth Embodiment

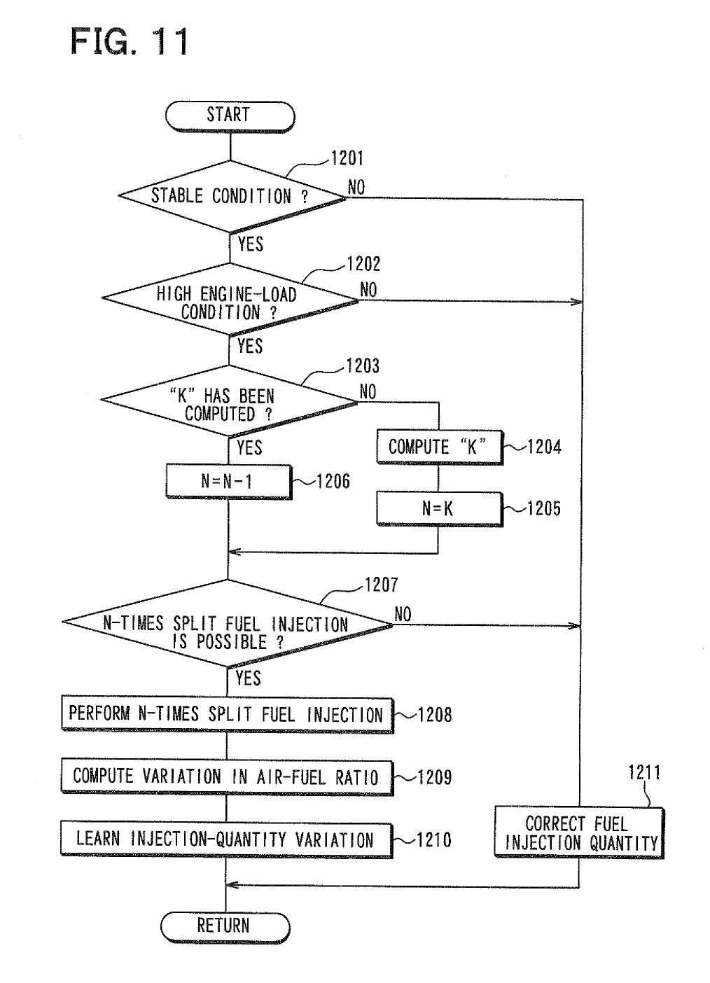

Referring to FIG. 11, a fourth embodiment will be described hereinafter. In the fourth embodiment, the same parts and components as those in the third embodiment are indicated with the same reference numerals and the same descriptions will not be reiterated.

According to the present embodiment, the ECU 142 executes an injection-quantity variation learning routine shown in FIG. 11. The number N of split fuel injection is sequentially changed to learn the injection-quantity variation of the fuel injector 121, so that the injection-quantity variation is learned in multiple fuel injection quantity ranges.

In step 1201, the computer determines whether the engine driving condition (engine speed, engine load and the like) is stable. When the answer is YES in step 1201, the procedure proceeds to step 1202 in which the computer determines whether the engine is driven in high engine-load condition. When the answer is YES in step 1202, the procedure proceeds to step 1203 in which the computer determines whether an initial value K of the number N has been computed.

When the answer is NO in step 1203, the procedure proceeds to step 1204 in which the initial value K of the number N is computed according to following formula.

K=Qtotal/Qapd (truncate after the decimal point)

Then, the procedure proceeds to step 1205 in which the initial value K is set as the split number N (N=K). Then, the procedure proceeds to step 1207 in which the computer determines whether the N-times split fuel injection can be performed. Specifically, based on whether the required fuel injection quantity per a single injection (Qtotal/N) is greater than or equal to the minimum fuel injection quantity of the fuel injector 121, the computer determines whether the N-times split fuel injection can be performed.

When the answer is YES in step 1207, the procedure proceeds to step 1208 in which the N-times split fuel injection is performed in each cylinder. Then, the procedure proceeds to step 1209 in which the variation in air-fuel ratio of each cylinder is individually computed based on the output of the air-fuel ratio sensor 124.

Then, the procedure proceeds to step 1121 in which the injection-quantity variation of each cylinder in low engine-load condition is individually computed based on the variation in the air-fuel ratio of each cylinder. These computed injection-quantity variations of each cylinder are stored in the nonvolatile memory as the learning values of the variations.

When the answer is YES in step 1203, the procedure proceeds to step 1206 in which the split number N is decreased by “1” (N=N−1). Thereby, the required fuel injection quantity per one injection (Qtotal/N) is increased more than the previous required fuel injection quantity and the fuel injection quantity region in which the learning is conducted is changed.

Then, the procedure proceeds to steps 207-210 sequentially.

When the answer is NO in step 1201, step 1202 or step 1207, the procedure proceeds to step 1211 in which the computer reads out the learning values of the injection-quantity variation of each cylinder, which correspond to the current required fuel injection quantity. Based on these learning values, the computer individually corrects the fuel injection quantity with respect to each fuel injector 121.

In the above fourth embodiment, the split number N is sequentially changed to learn the injection-quantity variation in multiple fuel injection quantity region. Thus, the fuel injection quantity per a single injection is sequentially changed and the fuel injection quantity region for learning is sequentially changed. The injection-quantity variations in multiple fuel injection quantity regions can be learned promptly.

### Fifth Embodiment

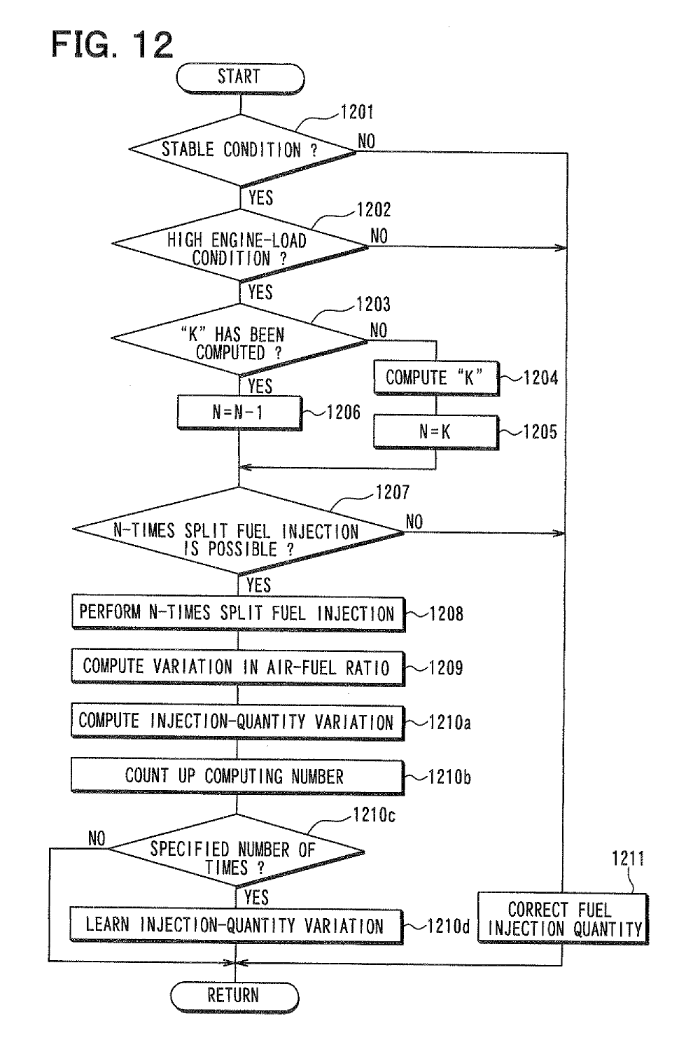

Referring to FIG. 12, a fifth embodiment will be described hereinafter. In the fifth embodiment, the same parts and components as those in the fourth embodiment are indicated with the same reference numerals and the same descriptions will not be reiterated.

According to the present embodiment, the ECU 142 executes an injection-quantity variation learning routine shown in FIG. 12. The injection-quantity variation in a specified fuel injection quantity region is computed specified number of times under multiple engine driving conditions. Based on these computed variation, the learning values of the variations in the fuel injection quantity are determined in the fuel injection quantity region. A routine shown in FIG. 12 is different from the routine shown in FIG. 11 only in that the process in step 1210 in FIG. 11 is replaced by processings in step 1210a-1210d. The other steps in FIG. 12 are the same as those in FIG. 11.

In step 1209, the variation in air-fuel ratio of each cylinder is individually computed based on the output of the air-fuel sensor 124. Then, the procedure proceeds to step 1210a in which the injection-quantity variation is individually computed with respect to each fuel injector 121.

Then, the procedure proceeds to step 1210b in which a computing number of the injection-quantity variation in the present fuel injection quantity region is counted up. If the engine driving condition has not been changed, the computing number is not counted up.

Then, the procedure proceeds to step 1210c in which the computer determines whether the injection-quantity variation is computed specified number of times in different driving condition based on whether the computing number of the injection-quantity variation reaches a specified number.

When the answer is YES in step 1210c, the procedure proceeds to step 1210d. In step 1210d, an average of the variations in fuel injection quantity computed specified number of times is computed with respect to each cylinder. These computed average variations in fuel injection quantity of each cylinder are stored in the nonvolatile memory as the learning values of the variations.

According to the fifth embodiment, since an average of the variation in fuel injection quantity is determined as the learning value of the variation, the learning accuracy of the variations can be improved and robustness can be obtained with respect to a variation in engine driving condition.

In the above fifth embodiment, when the injection-quantity variations are computed specified number of times in different engine drive condition, the average of the variations is determined as the learning value. However, without respect to the engine driving condition, the average of the variations can be determined as the learning value.

According to the above described embodiments, while performing the split fuel injection, the variation in air-fuel ratio is individually computed with respect to each cylinder. Based on the variation in air-fuel ratio of each cylinder, the injection-quantity variation is individually learned with respect to each cylinder.

Alternatively, the split fuel injection may be performed in a selected cylinder. While executing the split fuel injection, the variation in air-fuel ratio may be computed with respect to the selected cylinder. In this case, the selected cylinder is successively changed, whereby the injection-quantity variation can be learned with respect to every cylinder.

The present invention can be applied to an intake port injection engine as well as the direct injection engine.

What is claimed is:

1. A fuel injection controller for an internal combustion engine, comprising:
an air-fuel ratio sensor provided in an exhaust passage of the internal combustion engine; and
an information computing means for performing a split fuel injection in which a required fuel injection quantity is injected by multiple fuel injections when the engine is driven in a high load condition where a load of the engine is greater than a specified load value and the required fuel injection quantity of each cylinder is greater than a specified quantity value, wherein
based on an actual air-fuel ratio detected by the air-fuel ratio sensor during the split fuel injection and a specified reference air-fuel ratio, the information computing means computes an injection-quantity variation information which represents an injection-quantity variation or an information correlating with the injection-quantity variation in a low load condition where the load of the engine is less than the specified load value.

2. A fuel injection controller according to claim 1, further comprising
an air-fuel ratio computing means for individually computing an actual air-fuel ratio with respect to each cylinder based on an output of the air-fuel ratio sensor, wherein
the information computing means performs the split fuel injection when the engine is driven in the high load condition, and
the information computing means individually computes the injection-quantity variation information in the low load condition with respect to each cylinder based on the actual air-fuel ratio computed during the split fuel injection and the reference air-fuel ratio.

3. A fuel injection controller according to claim 1, wherein
the information computing means performs the spilt fuel injection through a fuel injector provided to a specified selected cylinder, and
the information computing means individually computes the injection-quantity variation information in the low load condition with respect to the selected cylinder based on the actual air-fuel ratio detected by the air fuel ratio sensor during the split fuel injection and the reference air-fuel ratio.

4. A fuel injection controller according to claim 1, wherein
the reference air-fuel ratio is a required air-fuel ratio for a normal fuel injection in which the required fuel injection quantity is injected by a single fuel injection.

5. A fuel injection controller according to claim 1, wherein
the reference air-fuel ratio is an actual air-fuel ratio detected by the air-fuel ratio sensor when a normal fuel injection is performed, in which the required fuel injection quantity is injected by a single fuel injection.

6. A fuel injection controller according to claim 2, wherein
the reference air-fuel ratio is an actual air-fuel ratio of a specified representative cylinder computed by the air-fuel ratio computing means when the split fuel injection is performed in each cylinder.

7. A fuel injection controller according to claim 1, further comprising
a correction value learning means for learning a correction value with which the injection-quantity variation is corrected based on the injection-quantity variation information computed by the information computing means, and
an injection quantity correcting means for correcting the fuel injection quantity based on the correction value leaned by the correction value learning means.

8. A fuel injection controller for an internal combustion engine comprising:
an air-fuel ratio sensor provided in an exhaust passage of the internal combustion engine; and
a variation learning means for performing a split fuel injection in which a required fuel injection quantity is injected by multiple fuel injections when the engine is driven in high engine-load condition where the required fuel injection of each cylinder is greater than a specified value, wherein
the variation learning means learns an injection-quantity variation in low engine-load condition based on a variation in air-fuel ratio which is obtained from an output of the air-fuel ratio sensor while the split fuel injection is performed, and
the variation learning means determines a number of times of a fuel injection in the split fuel injection based on a fuel injection quantity which is within a specified fuel injection quantity range where a learning of the injection-quantity variation is executed.

9. A fuel injection controller according to claim 8, further comprising:
an air-fuel ratio variation computing means for individually computing a variation in an air-fuel ratio with respect to each cylinder based on the output of the air-fuel ratio sensor, wherein
the variation learning means performs the split fuel injection when the load of the engine is greater than a specified value, and
the variation learning means individually learns the injection-quantity variation in the low engine-load condition with respect to each cylinder based on the variation in air-fuel ratio of each cylinder.

10. A fuel injection controller according to claim 8, wherein
the variation learning means sequentially changes the number of times of the fuel injection in the split fuel injection so as to learn the injection-quantity variations in multiple fuel injection quantity ranges.

11. A fuel injection controller according to claim 8, wherein
when the variation learning means computes the injection-quantity variations in a specified fuel injection quantity range a specified number of times, the variation learning means determines a learning value of the injection-quantity variation based on the computed injection-quantity variations.
